(19) United States
(12) Patent Application Publication
(10) Pub. No.: US 2003/0208443 A1
(43) Pub. Date: Nov. 6, 2003

(54) Electronic payment systems and methods

(76) Inventor: Dean Mersky, Malibu, CA (US)

Correspondence Address: ROBERT D. FISH; RUTAN & TUCKER, LLP, P.O. BOX 1950, 611 ANTON BLVD., 14TH FLOOR, COSTA MESA, CA, 92628-1950, US

(21) Appl. No.: 10/088,816

(22) PCT Filed: Feb. 5, 2001
(86) PCT No.: PCT/US01/03752

(51) Int. Cl. G06F 17/60

(52) U.S. Cl. 705/40

(57) ABSTRACT

A third party (30) provides a vendor (20) with immediate payment (32), bills the customers (10), while still providing the vendor (20) with a substantial upside benefit for customers (10) that settle their accounts in a desirable fashion. The methods and systems can be conveniently implemented using an improved hand carried electronic transaction device that concurrently displays different first and second account codes. The methods and systems are contemplated to be particularly useful for doctors, dentists, and other professionals.

### FIELD OF THE INVENTION

The field of the invention is card-based electronic payment systems.

### BACKGROUND OF THE INVENTION

Customers generally need to have some way of paying for goods or services at the point of sale. In many instances customers already have sufficient funds, and can simply utilize any of numerous payment methods available. Known methods include payment with cash, writing a check, using a debit card, or withdrawing money from a savings account. In other instances customers can rely on some or third party financing, whether in the form of a credit card, bank loan, credit line, or other credit arrangement.

Problems arise, however, when a customer is either unable or unwilling to sufficiently access his or her own cash or credit. In such instances the transaction can generally only be completed when the vendor provides the funding.

Of course, it is known for vendors to find transactions from their own working capital. Professionals such as doctors, lawyers, and accountants, and even many small professional firms fund much of their accounts receivable in this manner. Often, however, many vendors find that funding from working capital is an inefficient or otherwise undesirable use of resources.

Another method of vendor financing is vendor borrowing. Here, the vendor either borrows a fixed amount from a financial institution or other funding entity, or takes a line of credit that can be accessed as needed. Unfortunately, however, vendor borrowing may also be unavailable because the vendor has insufficient collateral. Even where sufficient collateral is available, the effective cost of funds may be so high that this option becomes impractical.

Another method of vendor financing is factoring. Here, the vendor sells the accounts receivable at a discount to a “factor”, which then seeks reimbursement from the customer. Depending on the industry and a particular vendor's history, the discount commonly ranges anywhere from less than 10% to more than 50%. Factoring can be undertaken on a batch basis for groups of accounts receivable, or on an “immediate factoring” basis in which the factor pays the vendor separately for each transaction. Factoring has numerous benefits, including rapid payment to the vendor, and in some instances better recovery rate from customers because they are being billed by a third party. Unfortunately, factoring has significant drawbacks for many vendors, including relinquishment of the discount, which may eliminate most or all of the vendor's profit.

There is a further problem that transactions involving third parties generally require some sort of reliable authentication of the customer to the vendor, and some sort of reliable communication between the vendor and the third party. In the case of customer credit, this problem is often resolved through the use of credit cards. Authentication is provided by the customer having possession of the card, along with perhaps some corroborating identification. Communication between the vendor and the third party backing the credit card is provided by a telephone or other electronic link.

Currently available credit cards, however, generally provide access to only a single account code. If the funds needed to execute a given transaction exceed that available through the single account, then the customer generally must provide yet another credit card, or make some other arrangement to accommodate the difference. That circumstance can easily become problematic when the cost is much higher than estimated. For example, it is not uncommon for a patient to receive services from a medical or dental provider, only to discover that the charges greatly exceed the patient's estimates. Particularly in such circumstances, the patient may have considerable difficulty arranging for adequate payment at the point of sale. The likely outcome is that the professional carries the difference as accounts receivable, which is undesirable for the professional. The problem could be addressed by a card that concurrently displaying multiple account codes from different financial institutions. But to the best of the applicant's knowledge, such cards are unknown.

It has been suggested to provide an electronic card that selects and individually displays numerous account codes using the same magnetic stripe. See U.S. Pat. application Ser. No. 09/686,509 to Fish entitled “Multiple I/O Smart Cards”. But such cards arguably depend on a certain level of user sophistication that is not always present, and may be unusable in the even of electronic or power failure. It is also not taught or suggested in that application to display multiple account codes at the same time.

The ATT™ One Card™ does concurrently display two account codes, but one of the codes is a credit card number and the other coded is a telephone calling card number. The concept has apparently never been expanded to provide a card that concurrently displays account codes from different financial institutions. It certainly defies ordinary marketing strategies for a financial institution to go through the trouble and expense of issuing a credit card, and then concurrently displaying on the card an account code of a competing financial institution.

Thus, there is still a need to provide a credit card or other hand-carried electronic transaction device that satisfies the needs of concurrently displaying multiple account codes from different financial institutions. And since such devices would facilitate resolution of the sort of vendor financing problems discussed above, there is still a need for methods and systems m which a third party provides a vendor with immediate payment, bills the customers, and still allows the vendor to reap a substantial upside benefit for customers that settle their accounts in a desirable fashion.

### SUMMARY OF THE INVENTION

The present invention is directed to methods and systems in which a third party provides a vendor with immediate payment, bills the customers, while still providing the vendor with a substantial upside benefit for customers that settle their accounts in a desirable fashion. The methods and systems can be conveniently implemented using an improved hand carried electronic transaction device that concurrently displays different first and second account codes.

In one aspect a method of funding a purchase from a vendor comprises: a customer electronically providing an account code to the vendor to secure a payment for a customer transaction; the vendor electronically providing the account code to a funding entity, the funding entity remitting at least a portion of the payment to the vendor, and billing the customer for the transaction; and the funding entity attempting to collect a remittance from the customer, but having primary recourse against the vendor, and only contingent recourse against the customer if the vendor fails to make an adequate remittance.

In preferred embodiments the vendor is a professional and the transaction comprises purchasing professional services from the vendor. The transaction can be for any sort of goods or services. The finding entity can be a factor, although it can also comprise a bank, savings and loan or other financial institution, and may advantageously be related to a professional organization to which the vendor is a member.

The multiple account codes can facilitate payment in many different ways. Both codes can be credit card numbers, and alternatively or additionally, at least one of the codes can relate to an account that bills the customer, while having primary recourse to the vendor. It is particularly contemplated that at least two account codes are concurrently displayed on the magnetic stripe of a credit card.

The vendor may communicate financial details of the transaction to the finding entity using a public packaged switched network. Where insurance is involved, the vendor may advantageously communicate insurance-information related to the transaction along with, or at least a substantially at the same time as, the financial information is being transmitted. This is contemplated to be especially useful for medical or other professional insurance information, where both funding and insurance portions of the transaction can be conveniently facilitated by a third party.

Various objects, features, aspects and advantages of the present invention will become more apparent from the following detailed description of preferred embodiment of the invention, along with the accompanying drawing.

### BRIEF DESCRIPTION OF THE DRAWING

FIG. 1 is a schematic of the processing of a transaction.

FIG. 2A is a schematic of a post transaction processing of the transaction of FIG. 1, in which the funding entity seeks payment from the customer without having legal title to the accounts receivable.

FIG. 2B is a schematic of a post transaction processing of the transaction of FIG. 1, in which the funding entity seeks payment from the vendor without having legal title to the accounts receivable.

FIG. 2C is a schematic of a post transaction processing of the transaction of FIG. 1, in which the vendor seeks payment from the customer while having legal title to the accounts receivable.

FIG. 3 is an alternative view of the transaction of FIG. 1, including communication with an insurance information receiver and a credit card company.

FIG. 4A is a normal view of the front side of an electronic transaction card according to the inventive subject matter.

FIG. 4B is a normal view of the back side of an electronic transaction card according to the inventive subject matter.

### DETAILED DESCRIPTION

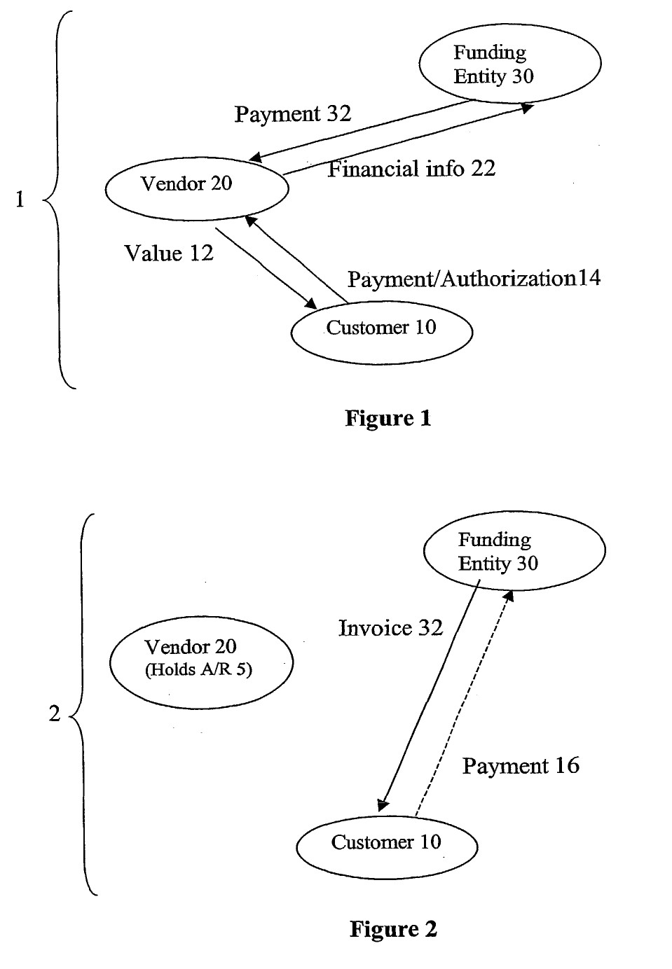

FIG. 1 depicts processing of a transaction 1 involving a customer 10, a vendor 20, a funding entity 30, and optionally an insurance information processor 40. In general, the customer 10 receives something 12 of value from the vendor 20, and pays for it with some form of payment or payment authorization 14 to the vendor 20. The vendor 20 then provides transaction related financial information 22 to the finding entity 30, and receives funds 32 from funding entity 30.

As used herein, the term “transaction” includes an exchange of anything of actual or perceived value, including consumables, durables, real property, financial instruments, and so forth, as well as professional or other services. Transactions 1 may also involve any relationship with respect to the parties involved and the transacted items, including purchase, lease, rent, and so forth.

Customers 10 are contemplated to include any entity that expects to make some form of payment for goods or services in a transaction. Correspondingly, vendors are contemplated to include any entity that expects to receive some form of payment for goods or services in the transaction. Thus, the terms “customers” and “vendors” include natural persons, as well as all forms of legal persons including dba entities, partnerships, corporations, and associations. It should also be appreciated that in some instances a customer may legally be represented by more than one individual. For example, if a husband and wife, or perhaps multiple cardholders at a business, all have credit cards bearing the same account number, the person actually receiving the goods or services in a transaction may not be the person or organization financially responsible for paying the bill. In such instances both entities are considered to be the customer as far as such terms are used herein.

The funding entity 30 can be any entity other than the customer 10 and the vendor 20 that provides finds to facilitate the transaction 1. Contemplated finding entities thus include banks, savings and loans, and other financial institutions, and well as funding entitys other than financial institutions, including factors, stock brokers, business associations, and even friends or relatives that provide funds.

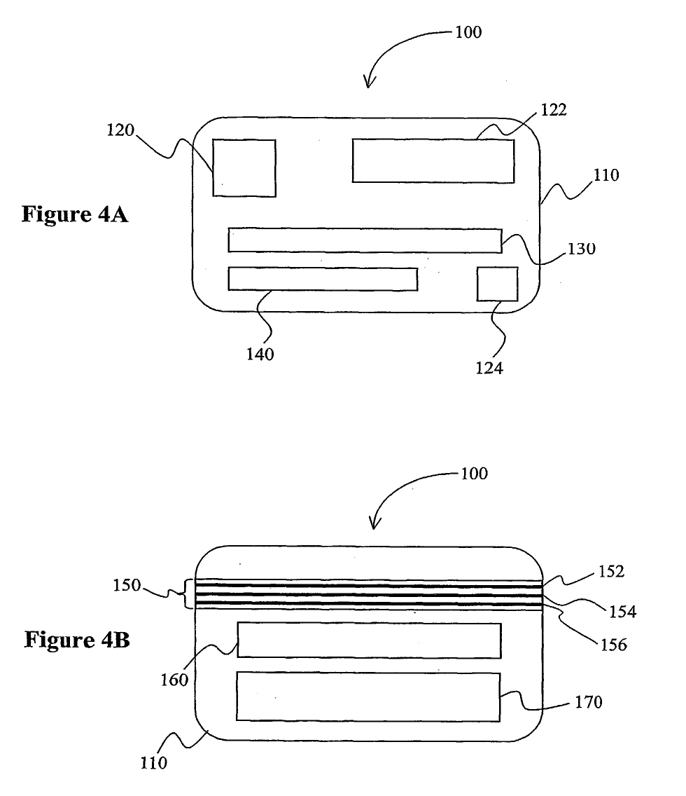

The payment or payment authorization 14 can include any recognized form of payment. This may include cash, check, credit card, debit card, or any combination of instruments. In especially preferred embodiments, the payment or payment authorization 14 involves an electronic transaction device such as that shown in FIGS. 4A and 4B, in which multiple account codes are displayed concurrently.

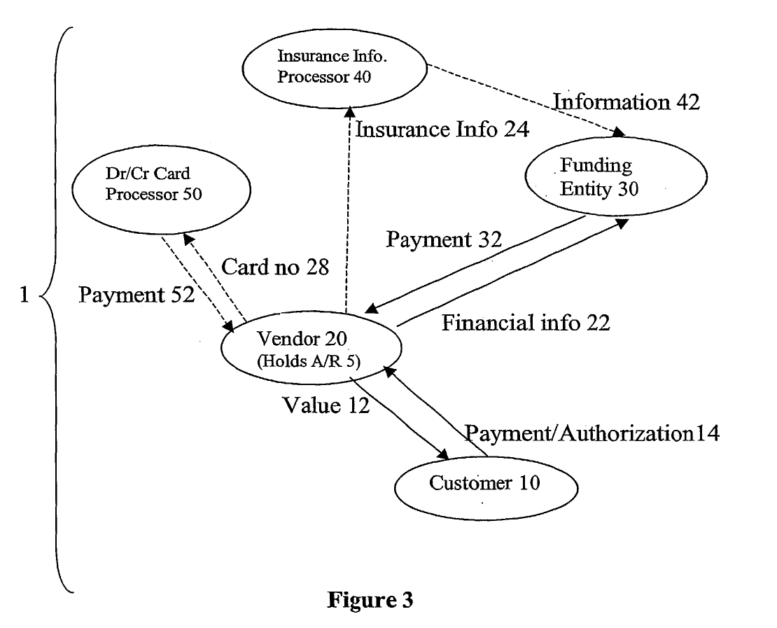

In transaction 1 the vendor 20 would typically submit an account code 22 to the finding entity 30 for payment. That account code 22 may or may not be an account code provided by the customer as part of the payment or payment authorization 14. Moreover, in preferred embodiments a credit/debit card account code provided by the customer 10 as part of the payment or payment authorization 12 would be sent to a credit card processor 50 (see FIG. 3) for payment, and a second code which may or may not come from the customer 10, is sent to the funding entity 30 for payment. The funding entity 30 would then make a payment 32 to or on behalf of the vendor 20. That payment 32 would almost certainly be less than the total charge for the transaction 1, to compensate the finding entity 30 for carrying a risk, for cost of capital, as well as for processing fees.

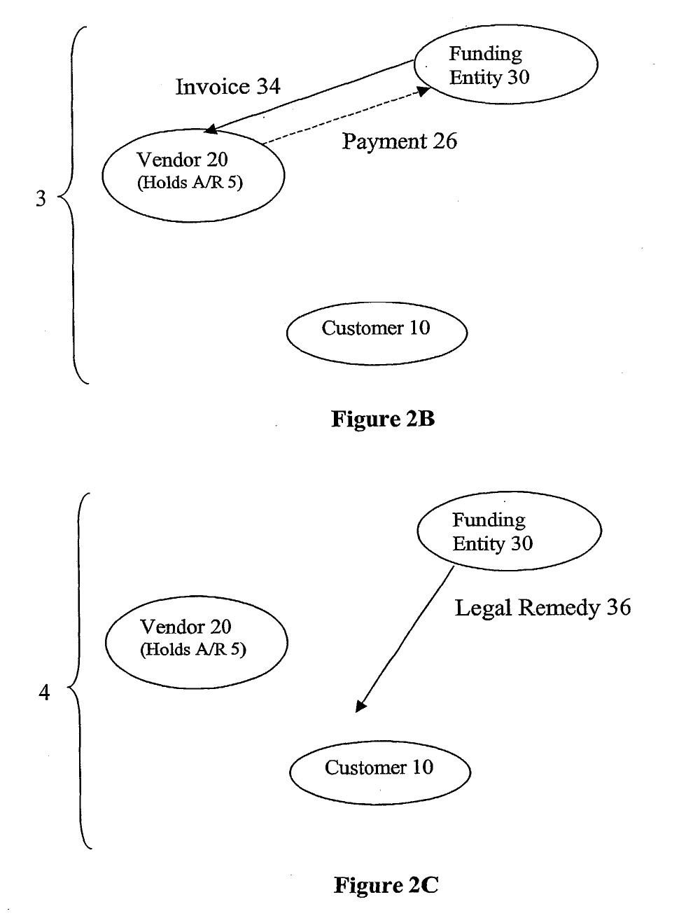

It is important to note that the vendor 20 holds the accounts receivable 5 during this process. Thus, even though the finding entity 30 is paying off the vendor 20 and has not yet collected from the customer, the accounts receivable 5 remains with the vendor 20. This is true at least to the extent that the vendor 20 is still the primary responsible party against which the finding entity 30 has recourse. In many instances the party having primary responsibility would not shift to the customer 10 until the accounts receivable 5 is transferred to the finding entity 30, as for example is shown in FIG. 2C.

Communication between the vendor 20 and the funding entity 30 can take place using any suitable systems and methods. Nevertheless, not all systems and methods are considered to be equally effective, and it is thought preferable to effect the communications rapidly and inexpensively. To this end it is contemplated that the communication may advantageously take place using a package switched network, more preferably a public package switched network, and most preferably with current technology, using the Internet. At points herein the term “immediately” or a derivative thereof may be used to describe an action, and in such instances the term should be interpreted as occurring rapidly—generally within two business days, more preferably within one business day, even more preferably within four hours, still more preferably within 1 hour, and most preferably within ten minutes.

FIG. 2A depicts a customer invoicing stage 2 wherein the funding entity 30 bills the customer 10 by sending invoice 32. It will of course be appreciated that invoice 32 (an all other documents discussed herein) can comprise a paper, electronic or other invoice, and can be transmitted by regular mail, e-mail, or any other type of communication. At this point the accounts receivable 5 still remains with the vendor 20. Hopefully the customer 10 makes a payment 16 that covers the balance due, but that payment 16 is shown as a dashed line to depict that the payment may be insufficient in to least some extent.

FIG. 2B depicts a vendor invoicing stage 3 wherein, we assume that the payment 16 was either missing or insufficient, and the finding entity 30 bills the vendor for the remaining balance using invoice 34. At this point the accounts receivable 5 still remains with the vendor 20, and hopefully the vendor 20 makes good on the full amount owed. That may or may not happen\, however, and that payment 26 is also depicted as a dashed line.

FIG. 2C depicts a legal recourse stage 4. Here, the customer defaulted or at least payment 16 was insufficient, the vendor has also defaulted or least payment 26 was insufficient and the accounts receivable 5 has been transferred to the finding entity 30. That gives the funding entity 30 the legal right to sue the customer 10 for any unpaid balance, as well as possibly costs, legal fees, and so forth. Optionally, the funding entity 30 may also seek legal remedy 36 against the vendor 20.

In a sense, some of the systems and methods described herein can be viewed as a new type of credit line. The line is contingently secured instead of unsecured, is generally accessible on a (patient) transaction basis, and generally only for the amount of the transaction. The amount of each transaction, most likely less a discount, transaction, or other fee, is electronically advanced from the line to the account of the vendor. The system will generate monthly patient billing statements, and may allow patients to make payments over time at a defined interest rate. Because the line belongs to the vendor, the vendor is in essence extending credit to the patient, but it the funding entity that is actually providing the funds. The vendor has primary responsibility for repaying the credit line, but the funding entity has the right to take over the accounts receivable from the vendor in the event of both customer and vendor default.

FIG. 3 is similar to FIG. 1, except that it includes an insurance information processor 40, and a credit/debit card processor 50.

The insurance information processor 40 can be an insurance company, a third party processing service for an insurance company, a third party processing service for a self-insured company, a re-pricing service, or any other entity that processes insurance information. The insurance information processor 40 may even be controlled by, or be a branch of, the finding entity 30. It is particularly contemplated that the insurance information processor 40 could handle paper and/or electronic claims.

In this instance the vendor 20 is providing insurance information 24 to the insurance information processor 40. Line 24 is dashed to depict the optional nature of the providing of the information 24. There is also another dashed line 42, depicting an optional information exchange between the insurance information processor 40 and the finding entity 30. The concept here is that the insurance information processor 40 may analyze the insurance information 24 provided by the vendor 20, approve all or some of a designated amount, and pass that approval information along to the funding entity 30.

The credit/debit card processor 50 can be any bank, savings and loan, or other entity that processes such cards. Here, the term “processor” is used to mean the entity that acts on behalf of a card issuer, and is responsible for resolving charges placed against a credit/debit portion of the card. Thus, a MasterCard™ issued by Wells Fargo™ bank may be processed by Wells Fargo™ bank, or by some third party processor. For an ATT™ One Card™ issued by a given bank, the credit/debit card processor 50 would likely be that bank, or again some third party processor working on behalf of the bank that is financially responsible for charges made against the credit portion of the card.

In FIG. 3, the credit/debit card processor 50 optionally receives a credit card number 28 from the vendor 20, and provides a payment 52 to the vendor, usually at the vendor's bank account. This scenario may occur in many instances, for example, where the customer 10 makes a partial payment using a credit card.

In FIG. 4A, an electronic transaction card 100 has a card body 110, upon which are printed a logo of an issuing institution 120, a description of the card 122, and a Visa, MasterCard, or other logo of a card issuing company. Embossed into the card body 110 is a card number 130, and cardholder information 140. FIG. 4B shows the reverse side of the electronic transaction card having a signature field 160, a secondary billing information field 170, and a transient data storage element 150, with a first data line 152, a second data line 154, and a third data line 156. Data associated with a first business entity are stored in the data lines 152 and 154, while data associated with a second business entity are stored in the data line 156.

In a preferred embodiment, the electronic transaction card is a Wells-Fargo credit card with a magnetic strip as a transient data storage element, wherein the front side has the logo of the issuing institution and credit card company, the description of the card, and the embossed information is sized and placed according to industry standards for credit and debit cards. On the back side of the card, the additional secondary billing information field contains the card user name, a unique identification number, and the address of a dental billing service. Also located on the backside of the card is a magnetizable strip as a transient data storage element is, which is also sized and placed according to the standards of a regular credit card. In addition to the first and second data line, which contains data associated with Wells-Fargo, the third data line contains data associated with the dental billing service.

In use, a customer has an electronic transaction card issued from a credit card company as the first business entity and the first and second data line on the magnetic strip contains data associated with the credit card company. The third data line contains data associated with a dental billing service to which the customer previously subscribed. The address of the billing service and the unique identification number are imprinted on the secondary billing information field. The customer receives a dental service at his dentist's office, and decides to use his electronic transaction card for payment of the service. The payment may be then be performed in one of two ways. The customer may decide to reimburse his dentist using the electronic transaction card as a regular credit card, a procedure well known to the art. Alternatively, the customer may decide to reimburse his dentist employing the dental billing service. In this case, the card is processed employing the data on the third data line, and the billing information on the electronic transaction card in the secondary billing information field is utilized to route the bill to the dental billing service.

With regard to the first and second business entity it should be recognized, that the inventive subject matter is not limited to a credit card company as a first business entity and a dental billing service as a second business entity. In contrast, first and second business entities may be any commercial and non-commercial business entity, and in further alternative aspects, more than two business entities may store data on the transient data storage element. For example, an electronic transaction card may have data associated with a credit card company, and data associated with a non-credit card company. This configuration enables a card user to decide which business entity may transact transfer of finding. In another example, contemplated electronic transaction cards may contain data associated with accredit card company and data associated with a bank, to enable a credit card function and debit card function on the same card. Thus, the contemplated electronic payment system is not limited to a credit card company and a dental billing service, but may include a wide variety of business entities other than a dental service such as law offices, retail chains, movie theaters, etc.

Of course the layout and other configuration features of contemplated cards can differ considerably from that depicted in FIGS. 4A and 4B. For example, the various fields on card 110 could be configured in other orders, so that the signature field 160 could be on the top, the secondary billing information field 170 could be in the middle, and the transient data storage element 150 could be on the bottom. Naturally, other issuing banks or entities could replace Wells-Fargo. Moreover, the billing information field 170, or other fields, may include identification or other information besides that described herein, so that the card could, for example, double as an insurance identification card. Such additional information may be present on either or both sides of the card.

Healthcare Business Model

Systems and methods herein can also be viewed from a healthcare business model perspective. Clinical services are typically provided through HMOs or other provider networks, through government programs, or through private practice. In the first two instances marginal charges incurred at the time of service are often either very small or non-existent, and accounts receivable is not generally a significant problem for the practitioner. In the case of private practice, however, such charges can be quite substantial. Since many patients resolve such charges through third party insurance payments, or accounts receivable carried privately by the treating practitioner, practitioners can be burdened with a significant cash flow drain.

Modern data processing systems have been developed to alleviate some of these problems. In many such systems, for example, it is known for the staff at a doctor or other provider's office to enter patient demographics data, diagnosis and treatment information, and then to print reimbursement requests to insurance companies in various standard formats. While such systems may reduce overhead, however, a significant problem often remains in that the third party payors may take months or even years to approve the charges and transfer finds to the service providers.

It is now contemplated to provide rapid payment to doctors and other providers by capturing charges on a computer system at or near the time of service, transferring funds from a funding entity to the provider within a very short period of time thereafter, and subsequently reimbursing the funding entity from the services recipient and/or a third party reimbursement source. In effect the inventive systems and methods provide that have similar results to immediate accounts receivable factoring.

In preferred systems and methods it is contemplated that services recipients can be identified through a card or other device issued by an appropriate agency. For example, services recipients can be identified by an insurance card, driver license, or credit card. It is especially contemplated that the identification device can serve a dual purpose, such as identifying a patient to the system, and acting as an ordinary credit card. It is also contemplated that services recipients can be identified alternatively or additionally through biometric means, such as thumb print readers or iris readers. Identification can be effected at many different points in the process, including at intake, exit, or even in exam or treatment rooms.

In another aspect of preferred systems and methods it is contemplated that a database can be used to store diagnosis and treatment information, which can advantageously be captured at or near the time of treatment. Signs and symptoms can also be captured and stored in the database, as can outcome information. Preferred databases for such purposes are self-evolving databases, in which previously entered information is automatically summarized and displayed to assist users in entering new information. In this manner doctors, for example, could readily see what treatments other doctors have historically employed for a given diagnosis, and what outcomes were associated with those treatments. Doctors may also be advised of differential diagnosis for a given set of signs and symptoms.

The database may be part of an intranet-extranet combined database, so that, for example, some of the information (such as doctor's name, specialty, and so forth) are available to the public, while access to other information (such as information relating to specific patients, diagnoses, treatments, and outcomes), can be restricted to the services provider, and access to still other information (such as some aspects of payment information) can be restricted to the finding entity.

The funding entity is contemplated to be a bank, professional organization, factor, or any other organization having sufficient resources. The amount of payment transferred from the finding entity to the services provider is contemplated to depend upon the treatment or other services provided, as well perhaps as the diagnosis or other factors. Geographic location, for example, may be a factor, so that payments may be higher in metropolitan areas than in rural areas.

It is especially contemplated that three potentially distinct aspects of clinical and/or other management software (what to do, what was done, and what charges are associated with what was done) all interact to settle all or at least a large portion of currently incurred charges at the point of service. In a clinical setting, for example, the software for (1) diagnosis, (2) treatment and outcome, and (3) benefits all interact to settle at least a large portion of the charges for a patient visit while the patient is still in the office. In such settings, the interaction of software would advantageously provide the doctor with guidance in diagnosis and treatment, preferably using a database that evolves predictions, and would do so automatically as a function of the doctor's submitting clinical data as part of the settlement process. The interaction of software would also provide “real-time” or near real-time settlement of charges, thereby greatly improving the doctors' cash flow.

Transfer of funds from the finding entity to the services provider may be with or without recourse, and may take into account a services recipient co-payment, and a greater or lesser financing factor (down to zero). It is also contemplated that reimbursement to the finding entity may be from one or any combination of ultimate payors, including the services recipient, a guarantor, an insurance company, government agency, or other third party payor.

While the above discussion has focused on clinical practice, corresponding systems and methods are also applicable to other services or product industries—especially where there is a prevalence of third party payors. Thus, it is contemplated that automobile repair shops may make suitable use of the systems and methods described herein.

Thus, specific embodiments and applications of electronic payment systems and methods have been disclosed. It should be apparent, however, to those skilled in the art that many more modifications besides those already described are possible without departing from the inventive concepts herein. Furthermore, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. A method of funding a purchase from a vendor, comprising:
a customer electronically providing a first account code to the vendor to secure a payment for a customer transaction;
the vendor electronically providing the first account code to a finding entity;
the finding entity remitting at least a portion of the payment to the vendor, and billing the customer for the transaction; and
the funding entity attempting to collect a remittance from the customer, but having primary recourse against the vendor, and only contingent recourse against the customer if the vendor fails to make an adequate remittance.

2. The method of claim 1 wherein the vendor is a professional and the transaction comprises purchasing professional services from the vendor.

3. The method of claim 1 wherein the transaction comprises purchase of goods.

4. The method of claim 1 wherein the transaction comprises purchase of a service.

5. The method of claim 1 wherein the finding entity comprises a factor.

6. The method of claim 1 wherein the funding entity comprises a financial institution.

7. The method of claim 1 wherein the finding entity is related to a professional organization to which the vendor is a member.

8. The method of claim 1 wherein the vendor secures a second account code from the purchaser, and the second account code is used in paying a portion of the payment for the transaction.

9. The method of claim 8 wherein the vendor secures both the first and second account codes from a single electronic transaction device carried by the purchaser.

10. The method of claim 9 wherein the electronic transaction devise comprises first and second machine readable display areas that concurrently display the first and second account codes.

11. The method of claim 1 further comprising the vendor communicating financial details of the transaction to the finding entity using a public packaged switched network.

12. The method of claim 1 further comprising the vendor substantially concurrently communicating financial details of the transaction and insurance information related to the transaction using a public packaged switched network.

13. The method of claim 12 wherein the insurance information comprises medical insurance information.

14. An improved hand carried electronic transaction device, wherein the improvement comprises first and second machine readable display areas that concurrently display different first and second account codes related to first and second financial institutions, respectively.

15. The device of claim 14 wherein the device comprises a credit card.

16. The device of claim 14 wherein each of the first and second display areas contain visually readable text.

17. The device of claim 14 wherein each of the first and second display areas contain tactually raised text.

18. The device of claim 14 wherein each of the first and second display areas comprise a portion of a magnetic stripe.

19. The device of claim 14 wherein the each of the first and second account codes are credit card numbers.
